(19) United States
(12) Patent Application Publication
(10) Pub. No.: US 2026/0199903 A1
(43) Pub. Date: Jul. 16, 2026

(54) SYSTEM, TOOL, AND METHOD FOR EJECTING SPECIMEN SAMPLES

(71) Applicant: QUEST DIAGNOSTICS INVESTMENTS LLC, Secaucus, NJ (US)

(72) Inventors: Alexander Mott, Overland Park, KS (US); Matthew Quick, Kansas City, MO (US); Bryan Bingham, Overland Park, KS (US); Matthew Theiss, Lenexa, KS (US)

(73) Assignee: QUEST DIAGNOSTICS INVESTMENTS LLC, Secaucus, NJ (US)

(21) Appl. No.: 19/133,338

(22) PCT Filed: Nov. 27, 2023
(86) PCT No.: PCT/US2023/081096

§ 371 Date: May 28, 2025

Related U.S. Application Data
(60) Provisional application No. 63/428,651, filed on Nov. 29, 2022.

(51) Int. Cl. B01L 9/06; B65D 25/52

(52) U.S. Cl. CPC B01L 9/06; B65D 25/52; B01L 2200/025

(57) ABSTRACT

A system for ejecting specimen samples includes a tray having a plurality of tray guide members and a plurality of holders configured to hold specimen samples. The system includes an ejector tool configured to eject the specimen samples. The ejector tool includes a base, a plurality of protruding members positioned on and extending away from the base, and a plurality of ejector guide members positioned on and extending away from the base and configured to engage the plurality of tray guide members of the tray such as to position the plurality of protruding members relative to specimen samples held in the tray. The plurality of protruding portions is configured to be inserted into the plurality of holders of the tray such that the plurality of protruding portions ejects the specimen samples from the plurality of holders.

### PRIORITY CLAIM

This application claims the benefit of and priority to U.S. Provisional Patent Application No. 63/428651, filed Nov. 29, 2022, which is hereby incorporated by reference in its entirety.

### TECHNICAL FIELD

The present disclosure relates to an ejector tool and system for ejecting specimen samples and a method thereof.

### BACKGROUND

Specimen samples may be held in a tray while the specimen samples are being tested. When testing of the specimen samples is complete or the specimen samples are no longer needed, it may be desirable to remove or eject specimen samples from the tray. However, individually removing samples from the tray can be time consuming and inefficient, particularly over an extended period of time. Additionally, because many specimen samples may be held in the tray at the same time, individually removing each specimen sample from the tray may involve repetitive pincer movements. These repetitive pincer movements present ergonomic concerns for a user removing the specimen samples and create an increased risk of injury.

### SUMMARY

In at least one exemplary embodiment, an ejector tool for ejecting specimen samples includes a base; a plurality of protruding members positioned on and extending away from the base; and a plurality of ejector guide members positioned on and extending from the base and configured to engage a corresponding plurality of tray guide members of a tray of specimen samples such as to position the plurality of protruding members relative to specimen samples held in the tray. The plurality of protruding portions is configured to be inserted into the tray of specimen samples such as to eject the specimen samples from the tray.

In another exemplary embodiment, a system for ejecting specimen samples includes a tray having a plurality of tray guide members and a plurality of holders configured to hold specimen samples; an ejector tool configured to eject the specimen samples, the ejector tool having a base, a plurality of protruding members positioned on and extending away from the base, and a plurality of ejector guide members positioned on and extending away from the base and configured to engage the plurality of tray guide members of the tray such as to position the plurality of protruding members relative to specimen samples held in the tray.

The plurality of protruding portions is configured to be inserted into the plurality of holders of the tray such that the plurality of protruding portions ejects the specimen samples from the plurality of holders.

Another exemplary embodiment includes a method for ejecting specimen samples using a system including a tray having a plurality of tray guide members and a plurality of holders configured to hold specimen samples, and an ejector tool having a base, a plurality of protruding members positioned on and extending away from the base, and a plurality of ejector guide members positioned on and extending away from the base and configured to engage the plurality of tray guide members of the tray such as to position the plurality of protruding members relative to specimen samples held in the tray, the method including: aligning the tray and the ejector tool by engaging the plurality of tray guide members with the plurality of ejector guide members; and relatively moving the tray and the ejector tool closer together to cause the plurality of protruding members to engage and initiate ejection of the specimen samples from the plurality of holders.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1A is a side perspective view of a system including an ejector tool engaged with a tray of specimen samples;

FIG. 1B is a side perspective view of the system including the ejector tool engaged with the tray of specimen samples in a different position;

FIG. 2 is another side perspective view of the system including the ejector tool engaged with the tray of specimen samples;

FIG. 3 is a top view of the ejector tool of FIG. 1A;

FIG. 4 is a side perspective view of the ejector tool, according to an exemplary embodiment;

FIG. 5 is another side perspective view of the ejector tool, according to an exemplary embodiment;

FIG. 6 is a bottom view of the ejector tool, according to an exemplary embodiment;

FIG. 7A is a perspective view of the tray of FIG. 1A without a cover;

FIG. 7B is a perspective view of the tray of FIG. 1A with the cover; and

FIG. 8 is a flowchart illustrating a method for ejecting specimen samples using a system including the ejector tool, according to an exemplary embodiment.

It will be recognized that the Figures are schematic representations for purposes of illustration. The Figures are provided for the purpose of illustrating one or more implementations with the explicit understanding that the Figures will not be used to limit the scope of the meaning of the claims.

### DETAILED DESCRIPTION

Following below are more detailed descriptions of various concepts related to, and implementations of, methods, apparatuses, and for providing an ejector tool for a system for ejecting specimen samples. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

Specimen samples may be held in a tray during, for example, testing of the specimen samples. Trays may contain many different specimen samples. After testing of the specimen samples is complete or the specimen samples are no longer needed, it may be desirable to remove or eject specimen samples from the tray. However, removing samples individually from the tray can be time consuming, particularly over an extended period of time, leading to reduced efficiency. Additionally, removing specimen samples individually from the tray requires a user to perform repetitive pincer movements, which may present ergonomic concerns for the user.

Implementations described herein are related to a system for ejecting specimen samples including a tray having a plurality of tray guide members and a plurality of holders configured to hold specimen samples. The system includes an ejector tool configured to eject the specimen samples. The ejector tool includes a base, a plurality of protruding members positioned on and extending away from the base, and a plurality of ejector guide members positioned on and extending away from the base. The plurality of ejector guide members is configured to engage the plurality of tray guide members of the tray such as to position the plurality of protruding members relative to specimen samples held in the tray. The plurality of protruding portions is configured to be inserted into the plurality of holders of the tray such that the plurality of protruding portions ejects the specimen samples from the plurality of holders. In this way, when inserted into the plurality of holders, the plurality of protruding portions simultaneously ejects the specimen samples from the plurality of holders. Therefore, a user is not required to remove each specimen sample individually. Further, simultaneously ejecting the specimen samples from the plurality of holders is more efficient as the user may be able to perform additional testing in less time. Further still, the user experiences fewer repetitive pincer movements, thereby helping to reduce discomfort and the risk of injury.

### II. Overview of Example Systems and Tools for Ejecting Specimen Samples

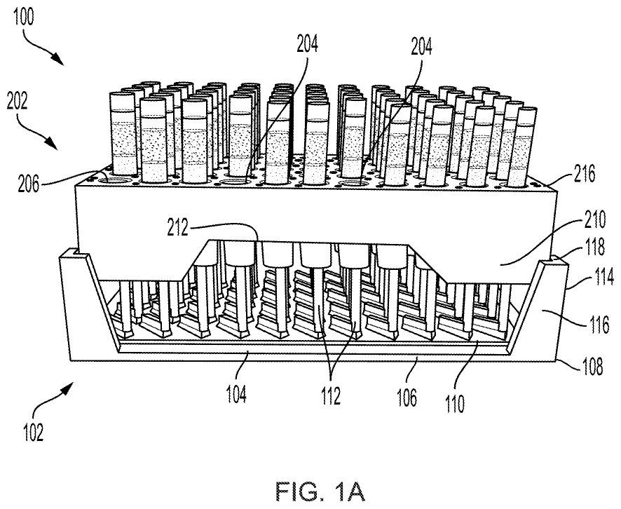

Referring to the Figures generally, FIGS. 1A-7B depict a system 100 (e.g., assembly, etc.) for ejecting specimen samples (e.g., biological samples, test tubes, vials etc.). The system 100 may be used to eject specimen samples more efficiently by enabling simultaneous ejection of all of the specimen samples, as compared to other systems that require each specimen sample to be removed individually.

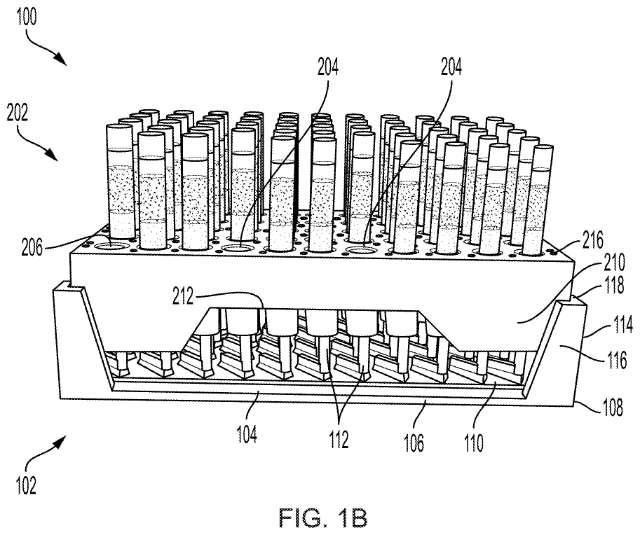

FIG. 1A depicts a side perspective view of the system 100 including an ejector tool 102 engaged with a tray 202 of specimen samples. FIG. 1B depicts a side perspective view of the system 100 including the ejector tool 102 engaged with the tray 202 of specimen samples such that the tray 202 has a different position relative to the ejector tool 102 as compared to FIG. 1A. FIG. 2 depicts another side perspective view of the system 100 including the ejector tool 102 engaged with the tray 202 of specimen samples. Referring to FIGS. 1A-2, the system 100 for ejecting specimen samples includes an ejector tool 102. The ejector tool 102 is configured to eject specimen samples. In some embodiments, the ejector tool 102 fully ejects the specimen samples, whereas in other embodiments, the ejector tool 102 may partially eject or displace the specimen samples. The ejector tool 102 includes a base 104 (e.g., body, block, etc.). The base 104 is configured to support components of the ejector tool 102. In some embodiments, the base 104 is configured to be held by a user (e.g., a laboratory technician, etc.). In other embodiments, the base 104 is configured to rest on or be coupled (e.g., attached, fixed, welded, fastened, riveted, adhesively attached, bonded, pinned, etc.) to a work surface (e.g., a laboratory bench, work station, counter, etc.).

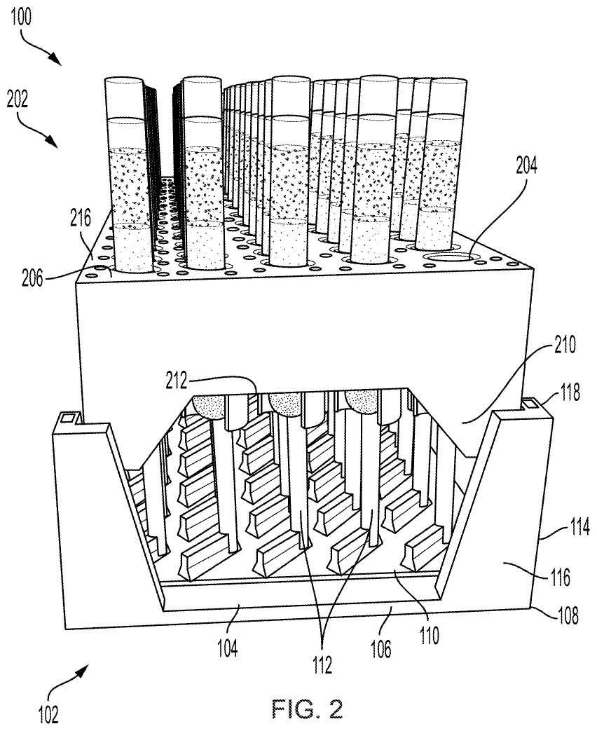

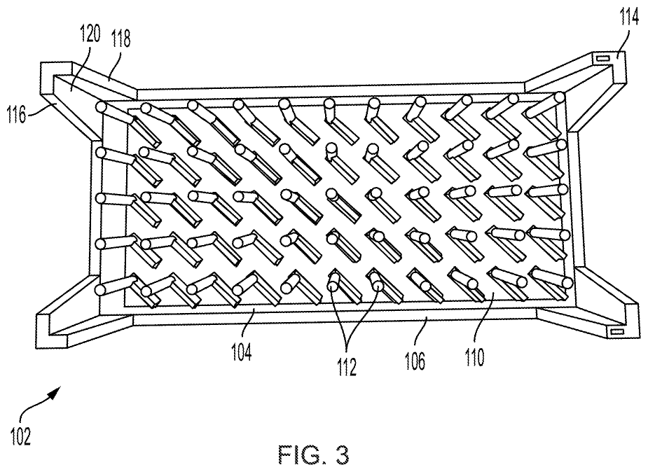

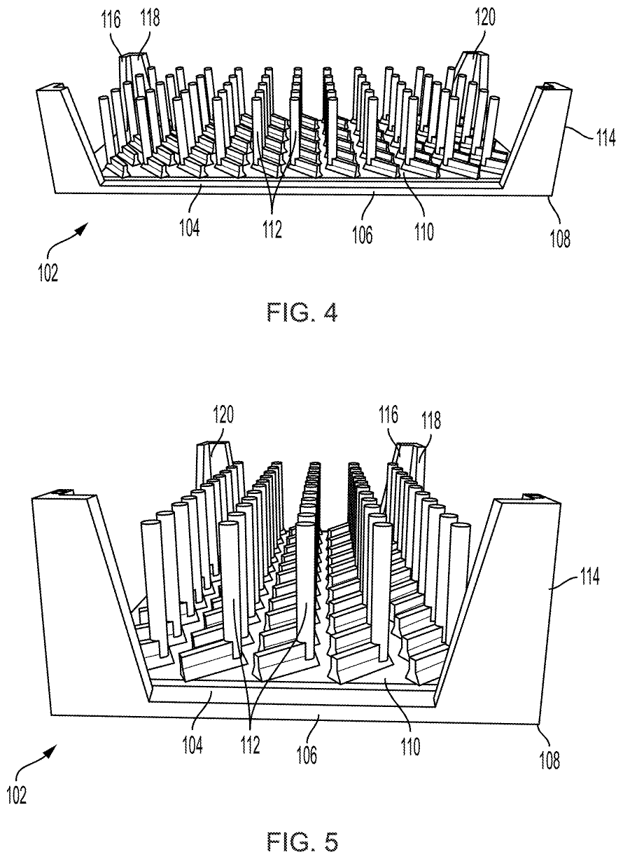

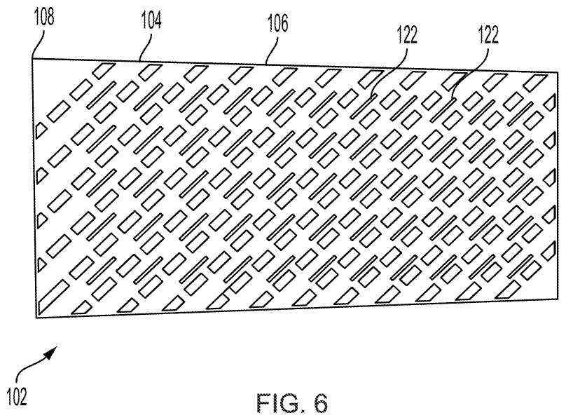

FIG. 3 depicts a top view of the ejector tool 102 of FIG. 1A. FIG. 4 depicts a side perspective view of the ejector tool 102, according to an exemplary embodiment. FIG. 5 depicts another side perspective view of the ejector tool 102, according to an exemplary embodiment. FIG. 6 depicts a bottom view of the ejector tool 102, according to an exemplary embodiment. Referring to FIGS. 1A-6, in some embodiments, the base 104 includes a plurality of sides 106 and a plurality of corners 108, each corner of the plurality of corners 108 being disposed between a side and another side of the plurality of sides 106. The plurality of sides 106 and the plurality of corners 108 may define a shape of the base 104. For example, the plurality of sides 106 and the plurality of corners 108 may be arranged such that the base 104 has a rectangular shape. However, the plurality of sides 106 and the plurality of corners 108 are not limited to the rectangular shape and may be configured in other orientations and shapes. Further, in some embodiments, each side of the plurality of sides 106 has the same shape and height, whereas in other embodiments, each side may have different shapes and heights (e.g., a curved side, a rectangular side, a flat side, an elevated side etc.). The plurality of sides 106 and the plurality of corners 108 may also define a base surface 110. In some embodiments, the base surface 110 is flat. Further, the base surface 110 may be a continuous surface, whereas in other embodiments, the base surface 110 may include openings 122 (e.g., slots, etc.), as seen in FIG. 6.

Referring to FIGS. 1A-5, in some embodiments, the ejector tool 102 includes a plurality of protruding members 112 (e.g., protrusions, rods, etc.). The plurality of protruding members 112 is positioned on and extends away from the base 104. For example, referring to FIG. 1A, the plurality of protruding members 112 extends perpendicularly away from the base 104. In some embodiments, the plurality of protruding members 112 is removable and replaceable from the base 104, as a prong of each of the plurality of protruding members 112 fits into an opening 122 of the base 104, and any number of the plurality of protruding members 112 may be removed and replaced. In some embodiments, the plurality of protruding members 112 is coupled to or integrally formed with the base 104. In some embodiments, the plurality of protruding members 112 may comprise plastic. In some embodiments, the plurality of protruding members 112 may be manufactured by a 3D printer. The plurality of protruding members 112 is positioned on the base 104 in a configuration (e.g., number of, arrangement of, etc.) corresponding to a configuration (e.g., number of, arrangement of, etc.) of the specimen samples of the tray 202. Consequently, the plurality of protruding members 112 may be positioned in different configurations on the base 104. For example, in some embodiments, the plurality of protruding members 112 is consecutively aligned along a length and a width of the base 104. Referring to the exemplary embodiment depicted in FIG. 3, the plurality of protruding members 112 includes 55 protruding members. Further, in some embodiments, each of the plurality of protruding members 112 has a shape corresponding to a shape of a corresponding holder of the plurality of holders 204. In some embodiments, a height of each of the plurality of protruding members 112 is uniform.

The plurality of protruding members 112 is configured to be inserted into the tray 202 of specimen samples such as to eject the specimen samples from the tray 202 of specimen samples. In other words, the plurality of protruding members 112 is received by the plurality of holders 204 of the tray 202 by relatively moving (e.g., pressing, squeezing, positioning, etc.) the tray 202 and the ejector tool 102 closer together. For example, as seen in FIG. 1B, the tray 202 and the ejector tool 102 are closer together than are the tray 202 and the ejector tool 102 as seen in FIG. 1A. In some embodiments, the plurality of protruding members 112 simultaneously ejects the specimen samples from the plurality of holders 204.

Referring to FIGS. 1A-5, in some embodiments, the ejector tool 102 includes a plurality of ejector guide members 114 (e.g., guides, supports, channels, etc.). The plurality of ejector guide members 114 is positioned on and extends away from the base 104. In some embodiments, the plurality of ejector guide members 114 is coupled to or integrally formed with the base 104. In some embodiments, the plurality of ejector guide members 114 extends away from the base 104 such that a height of the plurality of ejector guide members 114 is greater than the height of the plurality of protruding members 112. In some embodiments, each of the plurality of ejector guide members 114 is positioned at a corner of the plurality of corners 108 of the base 104. At each corner 108, each of the plurality of ejector guide members 114 may include a first portion 116 (e.g., side portion, extension, etc.). The first portion 116 extends away from the corner and along a side of the plurality of sides 106 of the base 104. Each of the plurality of ejector guide members 114 may also include a second portion 118 (e.g., side portion, extension, etc.). The second portion 118 extends away from the corner and along another side of the plurality of sides 106 of the base 104. In some embodiments, the first portion 116 and the second portion 118 intersect at the corner between the side and the other side of the plurality of sides 106. In some embodiments, the first portion 116 and the second portion 118 intersect to form an angle of approximately 90°, inclusive (e.g., 88°, 89°, 90°, 91°, 92°, etc.). Additionally, the first portion 116 and the second portion 118 may be tapered such that the first portion 116 and the second portion 118 decrease in length as the plurality of ejector guide members 114 extends away from the base 104.

The plurality of ejector guide members 114 is configured to engage a plurality of tray guide members 210 of the tray 202 such as to position the plurality of protruding members 112 relative to specimen samples held in the tray 202. For example, in some embodiments, each of the plurality of ejector guide members 114 comprises a channel 120 (e.g., corner, groove, slot, guide, etc.). The channel 120 is configured to engage (e.g., guide, direct, etc.) a corresponding tray guide member of the plurality of tray guide members 210. In some embodiments, the channel 120 includes the first portion 116. As described above, the first portion 116 is tapered such that the first portion 116 decreases in length as the plurality of ejector guide members 114 extends away from the base 104. Similarly, the channel 120 includes the second portion 118. The second portion 118 is tapered such that the second portion 118 decreases in length as the plurality of ejector guide members 114 extends away from the base 104.

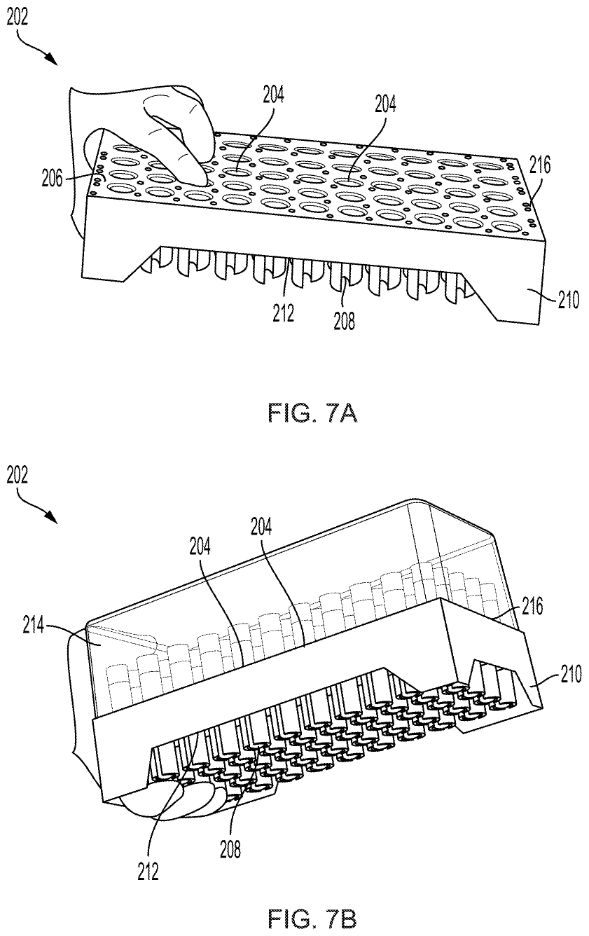

FIGS. 7A and 7B depict perspective views of the tray 202 of FIG. 1A without and with a cover 214. Referring to FIGS. 1A-2 and 7A-7B, in some embodiments, the system 100 for ejecting specimen samples includes a tray 202 (e.g., rack, etc.). The tray 202 is configured to house (e.g., hold, secure, arrange, etc.) specimen samples. In some embodiments, the tray 202 houses specimen samples while the user performs testing or other procedures on the specimen samples. Accordingly, the tray 202 may include a plurality of holders 204. The plurality of holders 204 (e.g., tray openings, slots, holes, etc.) is configured to hold the specimen samples in the tray 202. For example, in some embodiments, the plurality of holders 204 are openings, indentions, or holes in the tray 202 in which the specimen samples are held. In some embodiments, a bottom portion of a specimen sample rests on and is supported by a bottom portion of a holder of the plurality of holders 204. In some embodiments, the plurality of holders 204 engage with a collar (e.g., test tube collar, etc.) of the specimen samples to support the specimen sample. Further, the plurality of holders 204 may have a shape or size corresponding to a shape or size of a specimen sample such that the specimen sample securely fits within one of the holders 204. For example, the plurality of holders 204 may be cylindrical to hold a cylindrical test tube. Additionally, the plurality of holders 204 may hold the specimen samples such that the specimen samples are disposed or held at varying positions (e.g., heights, orientations, etc.) relative to the tray 202. For example, the specimen samples, when held by the plurality of holders 204, may extend above a top surface 206 of the tray 202, may be completely below the top surface 206 of the tray 202, or may be held such that, for each specimen sample, a portion of the specimen sample is below the top surface 206 of the tray 202 and another portion of the specimen sample is above the top surface 206 of the tray 202.

As described above, in some embodiments, the plurality of holders 204 is configured to receive the plurality of protruding members 112 to eject the specimen samples held in the plurality of holders 204. Accordingly, in some embodiments, the plurality of holders 204 is positioned on the tray 202 in the configuration corresponding to the configuration of the plurality of protruding members 112 of the ejector tool 102. For example, in the exemplary embodiment depicted in FIG. 7A, the plurality of holders 204 includes 55 holders. Similarly, in some embodiments, the tray 202 has a shape corresponding to the shape of the ejector tool 102. In this way, when ejecting the specimen samples, the tray 202 and the ejector tool 102 may be properly aligned such that the plurality of holders 204 receive the plurality of protruding members 112. In some embodiments, each of the plurality of holders 204 includes a receiving portion 208 (e.g., slot, hole, etc.). The receiving portion 208 receives a corresponding protruding member of the plurality of protruding members 112. In some embodiments, when each of the plurality of holders 204 receives the corresponding protruding member 112, the specimen sample held in each holder 204 is displaced. In some embodiments, the specimen samples are completely ejected from the tray 202. In other embodiments, the specimen samples are displaced (e.g., moved, pushed, etc.) relative to the top surface 206 of the tray 202 but partially remain within the plurality of holders 204.

Referring to FIGS. 1A-2 and 7A-7B, in some embodiments, the tray 202 includes a plurality of tray guide members 210 (e.g., guides, supports, channels, etc.). The plurality of tray guide members 210 is configured to engage with the plurality of ejector guide members 114. Specifically, a corresponding tray guide member of the plurality of tray guide members 210 engages with a corresponding ejector guide member of the plurality of ejector guide members 114. In this way, the tray 202 is able to be secured to the ejector tool 102 such that initiation and ejection of the specimen samples from the tray 202 may occur. In some embodiments, a corresponding tray guide member of the plurality of tray guide members 210 is received by the corresponding channel 120 of the plurality of ejector guide members 114. In some embodiments, the plurality of tray guide members 210 is configured to support the tray 202. In some embodiments, the plurality of tray guide members 210 is configured to elevate the tray 202, as discussed below.

Referring to FIGS. 7A-7B, the tray 202 includes a bottom surface 212 (e.g., surface, bottom face, etc.). In some embodiments, the specimen samples do not extend below the bottom surface 212. In some embodiments, when held in the plurality of holders 204, a portion of the specimen samples extends below the bottom surface 212. Further, in some embodiments, the plurality of tray guide members 210 is configured to elevate the bottom surface 212 relative to, for example, the work surface. Therefore, when the tray 202 is placed on the work surface, the portion of a specimen sample extending below the bottom surface 212 does not make contact with the work surface.

Referring to FIG. 7B, in some embodiments, the tray 202 includes a cover 214 (e.g., case, protective cover, etc.). The cover 214 is configured to removably attach (e.g., connect, couple, fit, etc.) to the tray 202 such as to enclose a portion of the specimen samples. For example, in some embodiments, the cover 214 attaches to the top surface 206 of the tray 202. The cover 214 may also attach to a rim 216 of the tray 202. In some embodiments, when the cover 214 is attached to the tray 202, the cover forms an air-tight seal. In this way, the cover 214 may prevent unintended displacement, spilling, or contamination of the specimen samples. Further, in some embodiments, the cover 214 is made of a transparent or semi-transparent material such that the user may view the specimen samples even when the cover 214 is attached to the tray 202.

### III. Example Method for Ejecting Specimen Samples

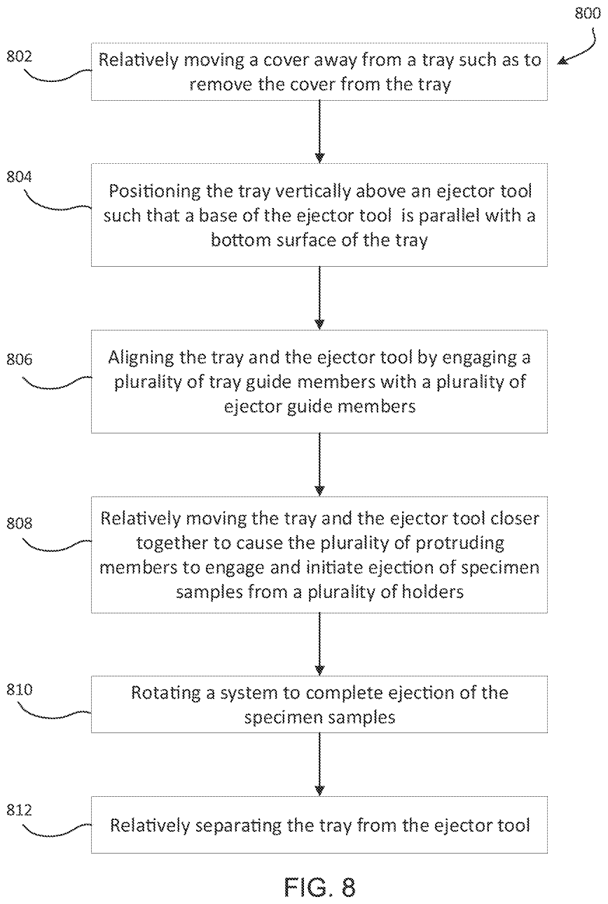

FIG. 8 illustrates a method 800 (e.g., process, etc.) for ejecting specimen samples using the system 100 having the ejector tool 102. The method 800 may be performed by, including but not limited to, a laboratory technician (i.e., when testing of the specimen samples is complete, the specimen samples are contaminated etc.). The method 800 described below is exemplary and non-limiting, and includes optional steps which may be omitted in some embodiments.

In some embodiments, the method 800 begins with step 802, which may be optionally performed before step 806. Step 802 includes relatively moving, when the cover 214 is attached to the tray 202, the cover 214 away from the tray 202 such as to remove the cover 214 from the tray 202. In this way, the specimen samples may be ejected from the tray 202.

In some embodiments, step 804 may be optionally performed also before step 806.

Step 804 includes positioning, before aligning the tray 202 and the ejector tool 102, the tray 202 vertically above the ejector tool 102 such that the base 104 is parallel or substantially parallel with the bottom surface 212 of the tray 202. In this way, each holder of the plurality of holders 204 is able to receive the corresponding protruding member of the plurality of protruding members 112.

The method 800 continues in step 806 by aligning the tray 202 and the ejector tool 102 by engaging the plurality of tray guide members 210 with the plurality of ejector guide members 114. In this way, the tray 202 and the ejector tool 102 are removably attached or fixed to one another.

The method 800 continues in step 808 by relatively moving the tray 202 and the ejector tool 102 closer together to cause the plurality of protruding members 112 to engage and initiate ejection of the specimen samples from the plurality of holders 204. In this way, each holder of the plurality of holders 204 receives the corresponding protruding member of the plurality of protruding members 112 to eject or displace the specimen samples.

In some embodiments, step 810 may be optionally performed after step 808. Step 810 includes rotating, after relatively moving the tray 202 and the ejector tool 102 closer together, the system 100 to complete ejection of the specimen samples. In this way, the ejected or displaced specimen samples are removed from the tray 202.

In some embodiments, step 812 may be optionally performed also after step 808. Step 812 includes relatively separating, after relatively moving the tray 202 and the ejector tool 102 closer together, the tray 202 from the ejector tool 102. In this way, the tray 202 may be prepared to receive additional specimen samples.

### IV. Configuration of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

What is claimed is:

1. An ejector tool for ejecting specimen samples, the ejector tool comprising:
a base;
a plurality of protruding members positioned on and extending away from the base; and
a plurality of ejector guide members positioned on and extending away from the base and configured to engage a corresponding plurality of tray guide members of a tray of specimen samples such as to position the plurality of protruding members relative to the specimen samples held in the tray,
wherein the plurality of protruding members is configured to be inserted into the tray such as to eject the specimen samples from the tray.

2. The ejector tool of claim 1, wherein the plurality of protruding members is consecutively aligned along a length and a width of the base.

3. The ejector tool of claim 1, wherein the plurality of protruding members is positioned on the base in a configuration corresponding to a configuration of the specimen samples of the tray.

4. The ejector tool of claim 1, wherein a height of each of the plurality of protruding members is uniform.

5. The ejector tool of claim 4, wherein the plurality of ejector guide members extends away from the base such that a height of the plurality of ejector guide members is greater than the height of the plurality of protruding members.

6. The ejector tool of claim 1, wherein the base has a plurality of sides and a plurality of corners between the plurality of sides, and
wherein each of the plurality of ejector guide members is positioned at one of the corners of the base.

7. The ejector tool of claim 6, wherein, at each corner, each of the plurality of ejector guide members comprises a first portion extending away from the corner and along a side of the base, and a second portion extending away from the corner and along an other side of the base, and
wherein the first portion and the second portion intersect at the corner.

8. The ejector tool of claim 7, wherein the first portion and the second portion are tapered such that the first portion and the second portion decrease in length as the plurality of ejector guide members extends away from the base.

9. A system for ejecting specimen samples, the system comprising:
a tray comprising a plurality of tray guide members and a plurality of holders configured to hold specimen samples; and
an ejector tool configured to eject the specimen samples, the ejector tool comprising:
a base,
a plurality of protruding members positioned on and extending away from the base, and
a plurality of ejector guide members positioned on and extending away from the base and configured to engage the plurality of tray guide members of the tray such as to position the plurality of protruding members relative to the specimen samples held in the tray,
wherein the plurality of protruding members is configured to be inserted into the plurality of holders of the tray such that the plurality of protruding members ejects the specimen samples from the plurality of holders.

10. The system of claim 9, wherein, when ejecting the specimen samples, the tray is disposed above the ejector tool such that the base is parallel with a bottom surface of the tray.

11. The system of claim 9, wherein the plurality of holders receives the plurality of protruding members by relatively moving the tray and the ejector tool closer together.

12. The system of claim 9, wherein the plurality of protruding members simultaneously ejects the specimen samples from the plurality of holders.

13. The system of claim 9, wherein each of the plurality of protruding members has a shape corresponding to a shape of a corresponding holder of the plurality of holders.

14. The system of claim 9, wherein each of the plurality of ejector guide members comprises a channel to engage a corresponding tray guide member of the plurality of tray guide members.

15. The system of claim 14, wherein the channel includes a first portion and a second portion that intersect to form an angle of approximately 90°.

16. The ejector tool of claim 15, wherein the first portion and the second portion are tapered such that the first portion and the second portion decrease in length as the plurality of ejector guide members extends away from the base.

17. A method for ejecting specimen samples using a system including a tray having a plurality of tray guide members and a plurality of holders configured to hold specimen samples, and an ejector tool having a base, a plurality of protruding members positioned on and extending away from the base, and a plurality of ejector guide members positioned on and extending away from the base and configured to engage the plurality of tray guide members of the tray such as to position the plurality of protruding members relative to specimen samples held in the tray, the method comprising:
aligning the tray and the ejector tool by engaging the plurality of tray guide members with the plurality of ejector guide members; and
relatively moving the tray and the ejector tool closer together to cause the plurality of protruding members to engage and initiate ejection of the specimen samples from the plurality of holders.

18. The method of claim 17, further comprising rotating, after relatively moving the tray and the ejector tool closer together, the system to complete ejection of the specimen samples.

19. The method of claim 17, further comprising positioning, before aligning the tray and the ejector tool by engaging the plurality of tray guide members and the plurality of ejector guide members, the tray vertically above the ejector tool such that the base is parallel with a bottom surface of the tray.

20. The method of claim 17, further comprising relatively separating, after relatively moving the tray and the ejector tool closer together, the tray from the ejector tool.
